(19) United States
(12) Patent Application Publication
(10) Pub. No.: US 2009/0304269 A1
(43) Pub. Date: Dec. 10, 2009

(54) Image Construction

(75) Inventor: Philip Willis, Wilts (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: University of Bath Research and Innovation Services, Bath (GB)

(21) Appl. No.: 12/438,880

(22) PCT Filed: Aug. 23, 2007
(86) PCT No.: PCT/GB2007/003205

§ 371 Date: May 28, 2009

(30) Foreign Application Priority Data
Aug. 25, 2006 (GB) 0616907.2

(51) Int. Cl. G06K 9/00

(52) U.S. Cl. 382/162; 382/284

(57) ABSTRACT

A method of creating a viewable image comprises applying a colour vector or matrix comprising colour values and a coverage value to a material represented as a projective transformation matrix including a further coverage value. The method further comprises rendering the transformed illumination vector or matrix as an image vector or matrix.

The invention relates to image construction and image representation, for example digital image construction and digital image representation. Image construction is known, for example, in compositing which is a process widely used in cinema, photography and computer games for combining two or more pixel images.

One known area of digital image construction is alpha compositing which is described in, for example, “Compositing Digital Images” ACM Computer Graphics 18, 3 (July 1984), 253 to 259 by Porter and Duff. This approach allows a combination of two or more images treated as overlaid layers, using linear interpolation to allow different amounts for contribution from different layers. According to this approach, when it is desired to combine the layers, each pixel in the respective image or layer can be represented by a conventional Red Green Blue (RGB) colour value together with an α value to provide a (R,G,B, α) vector which can be referred to as (C, α) or, in “pre-multiplied” form, (α C, α). These are utilised for the practical reason that all of their compositing calculations only use a colour coefficient when it is multiplied by its alpha value. It is therefore efficient to calculate this form once and to use and store it directly. As long as alpha is not zero, it is possible to recover the original colour (R,G,B) by dividing the pre-multiplied coefficients by the corresponding alpha value, a process which can be called normalisation. Alpha represents the colour coverage, typically normalised to one, in the pixel. Thus a colour (R,G,B,0.3) has an opacity of 0.3. The colour (R,G,B) contributes 0.3 of the colour and any other colour on a layer behind or beyond contributes the remaining 0.7.

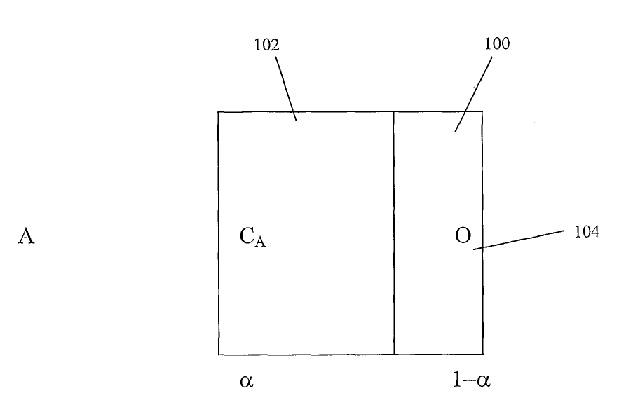

One way of representing this can be understood from FIG. 1 which shows a pixel 100 in layer A having a value (C_{A}, α). The α value represents the coverage of the pixel with colour C_{A} and so it can be seen that the pixel can be considered as having a coloured region 102 and a clear region 104 of proportions α, 1−α respectively. It will be appreciated that in practice the colour coverage on the pixel can be achieved in any appropriate manner, for example using an α-based density function. When two images A, B are combined, the respective α_{A}, α_{B} determine the proportion or contribution by each.

Various operations are supported in α compositing including a “paint” operation in which the front layer is shown fully and opaque, obscuring the rear layer, where the α of the front layer is set to 1. Alternatively fractional values of α allow additive blending between the front and back layers for example allowing feathering of edges of one element in an image into its background (the layer behind). Erase operations can also be supported by setting the α value of a layer to zero.

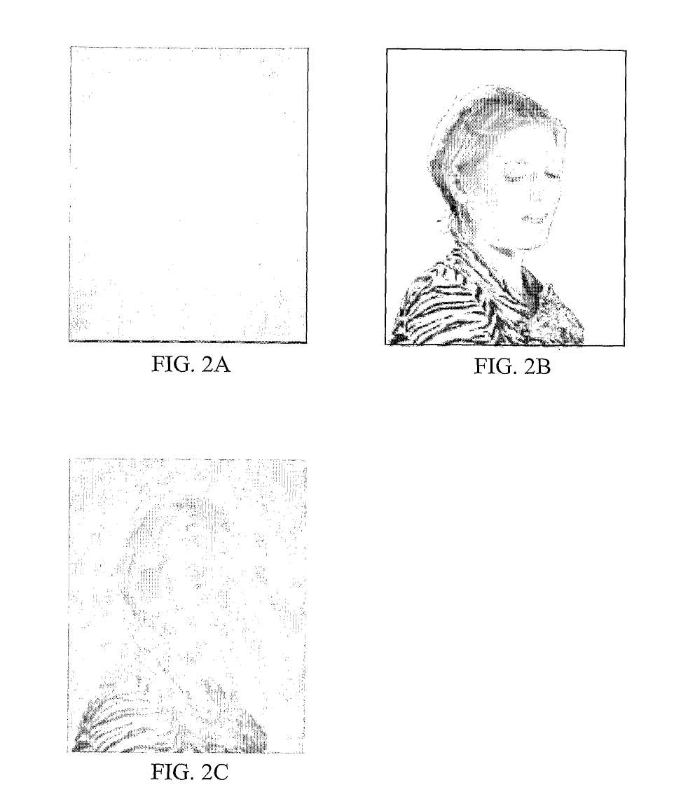

The use of α compositing of two input images can be further understood with reference to FIGS. 2A to 2C. FIG. 2A comprises a coloured splash used as a front image to be composited with a second image (FIG. 2B) as a rear image comprising a portrait, the portrait background having been suppressed by blue-screen techniques. FIG. 2C shows a standard α “over” operation with the foreground α set to 0.5, combining the colour splash of FIG. 2A with the face of FIG. 2B. Overall there is a foggy appearance, a consequence of the α average of the input images. In addition the colour splash is retained in the background at partial transparency.

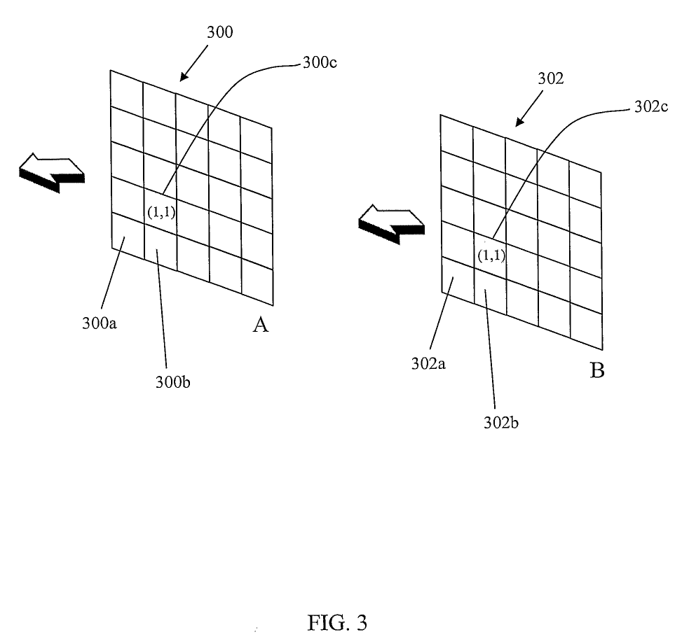

The approach can be further understood with reference to FIG. 3 which shows schematically a front image or layer A, 300 having pixels 300A, 300B etc and a rear layer, B, 302 having pixels 302A, 302B etc. For a corresponding pixel, for example pixel (1,1) 300C, 302C, the (RGBA) values for each are added. For example for an “over” operation, representing RGB_{A} as C_{A} and RGB_{B} as C_{B}, the resulting (C, α) values can be represented as:

C=α_{A}C_{A}+(1−α_{A})α_{B}C_{B}

α=α_{A}+(1−α_{A})α_{B} Equation (1)

As can be seen, therefore, the corresponding pixel of the output picture P_{(1,1)} is a simple addition of the individual pixel colour values premultiplied by the respective α values. Accordingly the effective physical model in α compositing is one of partial overpainting, such that it can only emulate the corresponding physical effect. For example if a yellow layer is placed over a black and white chequer board and a linear blend is provided between the layers, a yellow cast will be added to all squares, somewhat like spraying them thinly with yellow paint. In contrast a yellow filter would not affect the black squares because there is no light there. α mixing cannot emulate this and the utility of α mixing as a choice for combining layers is thus limited by its additive nature. In addition the α model does not cope with situations such as placing a filter over an illuminated layer which would change the contribution of the colour of that layer even though the filter is not illuminated. This is because the α model takes pixel values as given only allowing their adjustment for brightness directly or indirectly, with no interaction with the colour components of other layers.

A further technique has been proposed in “A physically based colour model”, Computer Graphics Forum 10, 2 (1991), 121-127 by Oddy and Willis, using a so called β value. This model recognises that the colour of an object can be decomposed into a reflected or scattered component (an illuminating effect) and a transmitted component (a filtering effect). Accordingly colours are specified as “materials” having both components, including a pigment which can be thought of as particles in the material that scatter back illumination, and a filter component in the form of the medium itself in which the pigment is “suspended”. A partially opaque material is thereby described as microscopic opaque coloured particles distributed in a clear, colourless medium. The density of particles seen from a particular direction determines the opacity. If an amount of a second material is placed behind the first, the latter's coloured particles will only be directly visible where they happen to fall in line with the first material's clear areas. In some places, particles from both layers will coincide and the resulting colour decided by how the two colours interact. Hence particle and medium colours can be individually defined for the material together with a factor (β) determining the relative proportion of particles to medium. When the factor is one the material is completely opaque and scatters light according to the colour of the particles. When the factor is zero the material is transparent and transmits light according to the colour of the medium. For intermediate values the material is translucent and exhibits a mix of these properties. Accordingly the factor, β defines the opacity of the material. If the particles are a different colour to the medium then a seven channel model is required giving the RGB values for the particles and medium together with the β value, that is,

(Particle colour, β, medium colour)

(Rₚ,Gₚ,Bₚ,β,Rₘ,Gₘ,Bₘ) Equation (2)

It will be seen that this enables all of the attributes of the α channel model to be simulated as a special case, when the medium is set to be colourless.

Accordingly by varying values of β it is possible to obtain effects beyond the α model including front and back illumination for example as though a layer is lit from the rear as well as the front. In this case the β value determines the scattering of light emanating forward towards the observer both as a function of front illuminating light scattered back towards the observer by the particles and rear illuminating light transmitted forwardly to the observer by the medium. The output image is stored in a pixel array with the output colours indicated (the β value is not required for the final output image).

Whilst the β model allows more complex compositing operations to take place, it requires a seven channel model for full operability and is based on a pixel-by-pixel approach.

The invention is set out in the claims.

Embodiments of the invention will now be described, by way of example, with reference to the drawings of which:

FIG. 1 shows a schematic pixel illustrating the prior art α compositing model;

FIG. 2A is a first layer to be α composited according to conventional techniques;

FIG. 2B is a second layer to be α composited according to conventional techniques;

FIG. 2C is the α composite of FIG. 2A and FIG. 2B

FIG. 3 is a schematic illustration of α-composited layers;

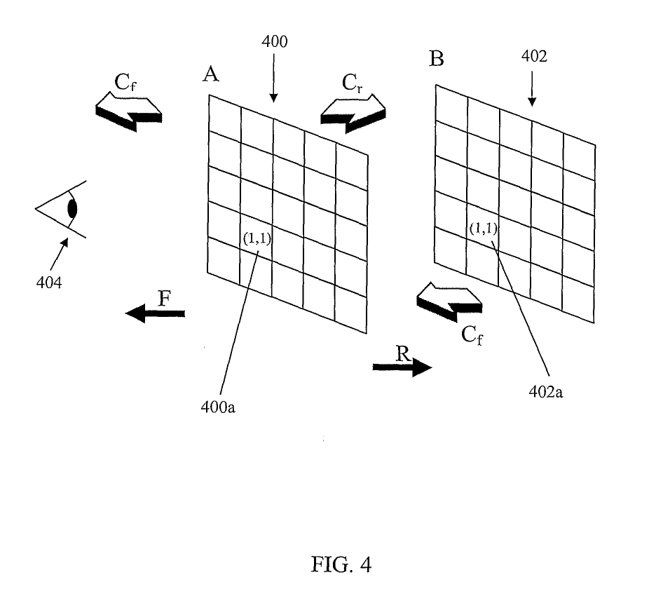

FIG. 4 shows compositing of layers according to the technique of the present invention;

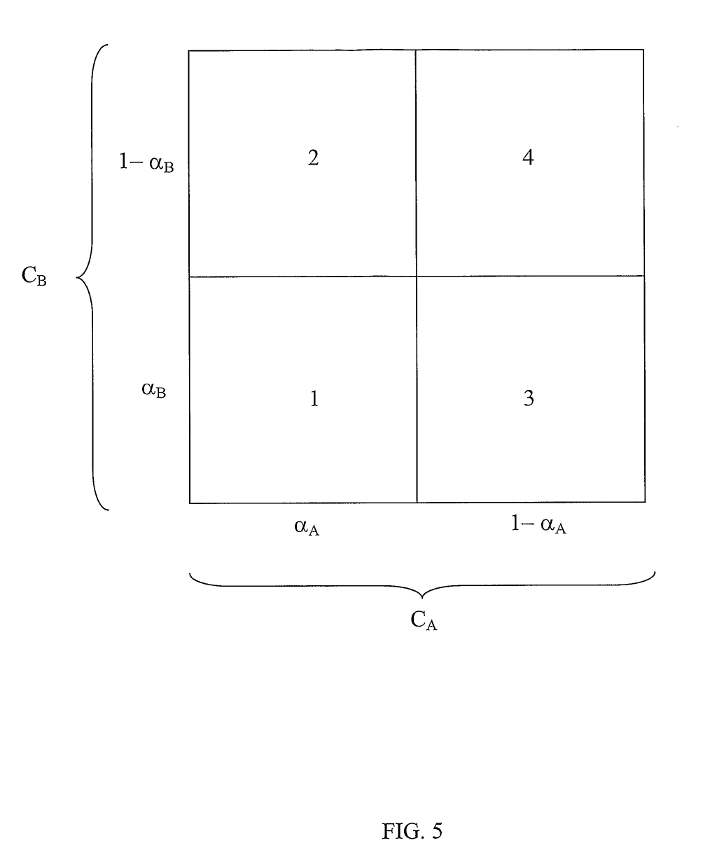

FIG. 5 shows schematically a pixel according to a generalised compositing approach of the present invention;

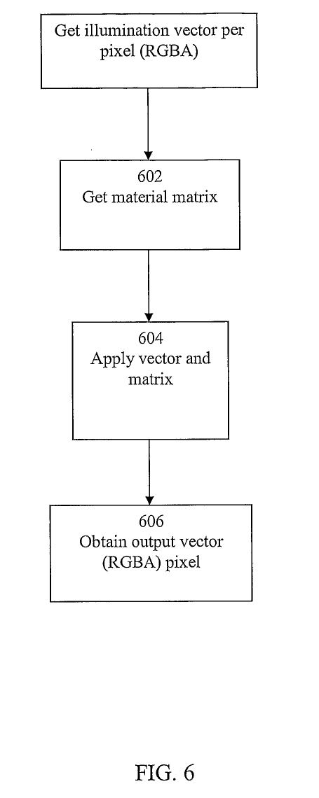

FIG. 6 is a flow diagram illustrating an image construction technique according to a first aspect of the invention;

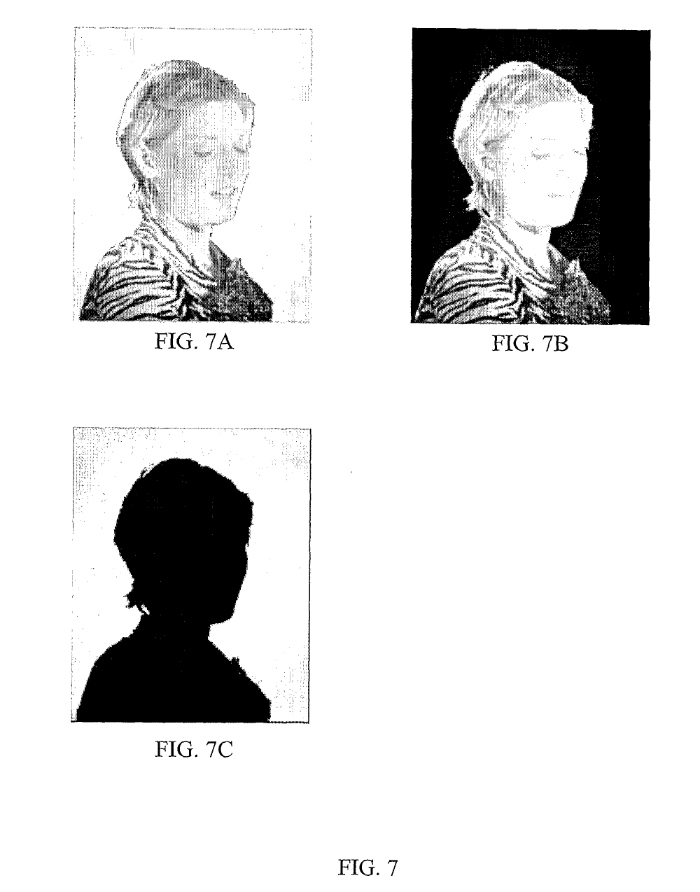

FIGS. 7A to 7C show the results of compositing according to the present method;

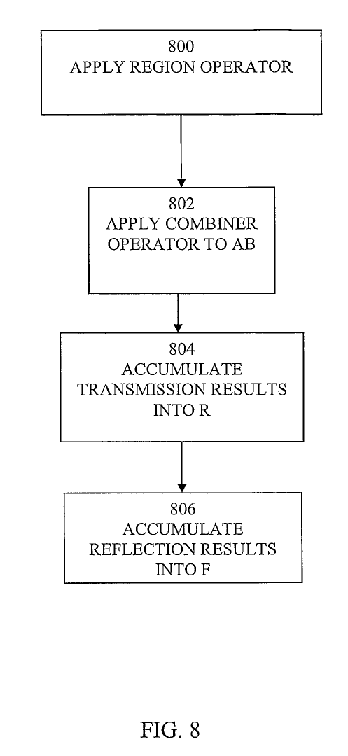

FIG. 8 is a flow diagram illustrating an image construction technique according to a second aspect of the invention;

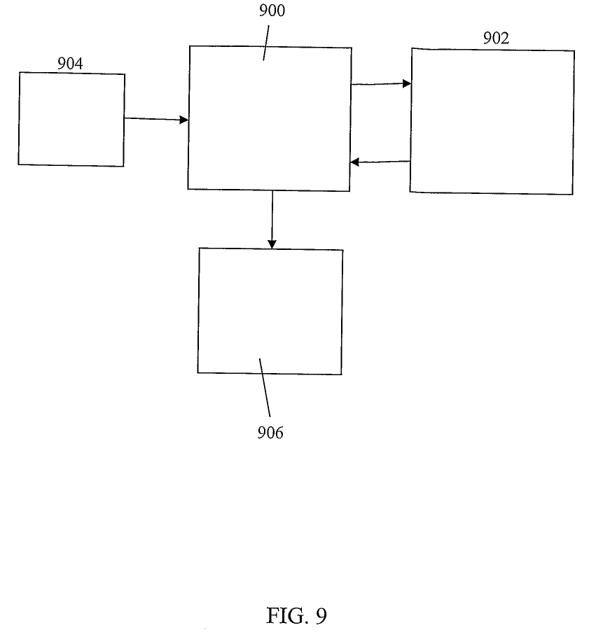

FIG. 9 is a schematic representation of an apparatus configured to perform the image construction operation described herein.

In overview, the invention involves three aspects.

In a first projective α colour aspect it is recognised that the (R, G, B, α) colour representation is mathematically equivalent to the homogenous representation of coordinates in projective geometry, a field which will be well known to the skilled reader as described in “The use of Projective Geometry in Computer Graphics” Herman I, Springer Lecture Notes in Computer Science, 564 (1992) which is incorporated herein by reference. Projective geometry is the study of projections of geometry on to different planes, represented by (x, y, z, w) where the w value maps the local space on to the projective space. In particular the projective transformations of projective geometry, which are represented as matrices, can be used analogously in α operations as representing materials, the corresponding transformation demonstrating the effect that material would have on an illuminating colour (R, G, B, α). In addition the effect of applying the transformation can be understood in physical terms by analogy with projective geometry transformation operations including, for example, colour shift, fluorescence, multispectral colours, scattering, filtering, scaling, subtractive colour compositing, darkening, rendering opaque and dissolving. Accordingly a full range of colour computations are available using only α values and not requiring, for example, the seven channels of the β model.

Projective 4-space can be thought of as Euclidean 3-space extended with the points and lines at infinity. The finite points are called “affine” and the infinite points are called “ideal”. This 4-space has certain properties which we will need to use. These are:
Property 1 Two distinct points define a line.
Property 2 Two distinct coplanar lines intersect at a point.
Property 3 In homogeneous coordinates, the set of projective points (wx,wy,wz,w),w≠0 are equivalent to the single Euclidean point (x,y,z).

These properties, with suitable variation, apply regardless of the dimensionality of the projective space. Property 1 applies whether the points are affine or ideal, in any combination. Property 2 might produce an affine point or an ideal point. This ability to cope with infinite points is of direct relevance in computer graphics, where parallel lines in 3D might project onto the image as intersecting lines. The intersection is called the vanishing point and can be thought of as the finite projected image of the infinite point where the parallel lines “meet”. For the projective plane there is only one such point: it does not matter in which direction we follow the parallel lines. More formally, this is the ideal point in the direction of the parallel lines.

The natural transformations of projective spaces are those that turn lines into lines. From this it can be shown that they turn intersection points into intersection points. We also note that when homogeneous coordinates are used, these transformations (and only these) can be represented by matrices. Properties 1 and 2 tell us that we are worldling with a projective space.

Property 3 is especially interesting to us. We do not need homogeneous coordinates to discuss projective geometry but they are an attractive way to do so. In our case they turn out to be fundamental to alpha compositing and this property is a key one. It says that, given a Euclidean point (x,y,z) the line of points (wx,wy,wz,w) are all the same projective point, even as w varies. If w=0 however, we can no longer tell which of the lines passing through the origin it falls on; in fact it falls on them all. We therefore have to be careful about w, which has a role distinct from (x,y,z).

We now argue that alpha colours form a projective space. We can clearly make a lexical substitution (ar, ag, ab, α) but there also has to be a basis in the laws of physics. (We will not consider aspects of colour which relate to the human eye or to human psychology; rather, we are concerned with practical issues of colour manipulation in computing hardware and software.) We therefore need to give physical meaning to (R,G,B) and to α.

In colour, we often use (R,G,B) coordinates. These may be thought of as a special case of multi-channel spectral coordinates, with the dimensionality set to three. As above, we will from time to time appeal to (R,G,B) for its familiarity but our worldling will not assume it. Initially we will show a colour C, meaning a vector. Each component of this vector will be a measure of energy in a selected frequency band. This is our physical interpretation of the colour dimensions.

We expect this energy space to be Euclidean. We note that it offers ideas of points, lines, planes and volumes; and that these all have a ready physical interpretation in colour. Pairs of distinct coplanar lines might intersect at a point but they do not do so if the lines are parallel. Parallel lines are colour lines separated by a constant colour. Distinct planes intersect at a line, unless they too are parallel. Importantly, C is unbounded; that is, we are not considering the unit colour cube, as we night for a pixel image or a display, but one in which indefinitely large finite values may occur. Negative colours can be thought of as colours which reduce the energy component of a sum of colours. This is the analogue of negative distances reducing a sum of distances. We do indeed have a Euclidean colour space.

We next turn to alpha. The w dimension is effectively a dimension of scale, with larger w normalising to give smaller Euclidean results. The case of w=0 cannot be used this way but, because it identifies ideal points, it never has to be used to normalise. We interpret alpha physically as the general volume containing the colour energy. If we are interested in volume data, it will be the 3D volume and so on for higher dimensions. If we are interested in surfaces in 3D or in 2D images, alpha amounts to area. Note however we are not defining it as the area of a pixel or as pixel coverage but as general area. Negative areas can be treated as something which reduces a sum of areas.

We now investigate whether (C,α) can be interpreted as a projective space. First we address infinite points, which are the added feature from the Euclidean case. Parallel Euclidean colour lines have a clear interpretation, being two coplanar lines separated by a constant colour: both lines share the same direction. In what sense can we say that this direction defines an infinite colour point? The interpretation is simply that, as both lines “reach” infinite energy, the finite energy difference between them is insignificant; both are the same colour at the infinite energy point. Moreover that colour is well defined, by the direction, and is distinct from that of any other direction.

Now we can ask if the three properties given earlier can be interpreted with these (C,α) colours?

Property 1 Two distinct points define a line.

Any two finite affine colours can be joined by a line. The line represents the linear interpolation of the colours, both within and beyond. If one point is ideal and one is affine then we have a point and a direction, which defines a line. If both are ideal, then the line is the line at infinity. Each of these results has a clear physical interpretation.

Property 2 Two distinct coplanar lines intersect at a point. This too has a clear interpretation at finite points. The infinite point case is justified by the direction argument just given, except when one of the lines is the line at infinity. In that case, the direction of the first line fixes an ideal point which, also being on the line at infinity, is the intersection point.

Property 3 In homogeneous coordinates, the projective points (wx,wy,wz,w),w≠0 are equivalent to the Euclidean point (x,y,z). If we scale both the colour and the alpha, then we are keeping fixed the energy density. So the points (α C,α) are equivalent to (C,I); that is, they are all the same colour (C) in Euclidean space.

In our interpretation, an alpha colour records the energy of the colour and the area (volume) it is held in. The energy density is energy per unit area, which is directly proportional to intensity and can be treated as such for our purposes. It follows that we can scale the homogeneous coordinates of a colour and still have the same intensity (Property 3).

We conclude that alpha colours (C,α) have an underlying projective space and that we can meaningfully interpret them in homogeneous coordinates. In turn this means we can use matrix operations.

It follows from the projective space that all points, except the origin, on the straight line through (C,α) and (−C,−α) represent the same Euclidean colour C. This gives a more general interpretation of negative colours and alphas. It also permits additive and subtractive colours to be represented in the same form. For example, printing can be explained with subtractive colours, where inks generally work by absorption and are non-spectral colours. The energy basis applies equally here however. Inventive aspects thus include

Additive and subtractive colours in the same representation; and/or

Use of colour coordinates other than spectral colours.

According to a second aspect, comprising an alternative compositing approach, in overview compositing of images is treated as compositing of a plurality of layers or layers using both illuminating/lighting and filtering effects applied to the layer, where, importantly, the output is represented by respective forward and rearward buffers. This is achieved by considering both the light emanating forwards towards the observer from the layer and that emanating away from the observer into the stack from the layer as separate image representations stored in respective forward and rearward buffers, in conjunction with compositing operations performed on the buffers, all defined in terms of α values.

This second aspect can be understood, in overview, with reference to FIG. 4 in which a front layer A, 400 and a rear layer B, 402 are shown. The forward energy C_{f} moving towards the viewer 404 and rearward energy Cᵣ moving away from the viewer are shown emerging from the front layer A. The rearward energy Cᵣ illuminates the rear layer B which may also be back illuminated. In practice every pixel of the layer will produce a pixel of the rearward buffer from the rearward energy Cᵣ and the pixel of the forward buffer from the forward energy C_{f} so that two images result. For example a pixel 400A at (1,1) contributes C_{f(1,1)} to the forward buffer and C_{r(1,1)} to the rearward buffer. Each of these is contributed as an (R, G, B, α) value and it will be seen that the same effects as for the β model can be obtained but using only four channel models, by splitting information into the two four channel buffers each of which can be treated as a standard α image. At the same time multiplicative combination of colours C_{A}, C_{B} can be provided modelling the more complex combination effects available from for example the β model, by replacing the general illumination in compositing operations with the relevant frame buffer from another layer and defining a compositing operation between the two layers. In order to obtain the output image the forward-buffer emanating from the front most layer can be obtained. Further information can be obtained from the I-buffer holding the current illumination at any point in the image. Either image can be used as an input to the next compositing operation as can any further input image layers dependent on operator requirements. Of course any number of layers can be used and a complex range of compositing operations can be defined using this approach.

In overview, according to a third aspect of the invention, the α projection approaches of the first aspect and the dual-buffer approach of the second aspect can be combined to perform image combinations, where projective transformations define the compositing operation between the layers represented as forward and rearward buffers using, for example, a 16 channel compositor.

Turning now to a more detailed description of the various aspects of the invention, the first aspect comprises projective α colour. Where the RGBA vector for each pixel, (R,G, B, α) is represented as (C,α), and talking α=1, α colours can be manipulated using “projections” that is transformations of each pixel where the transformation is represented by a matrix governing how illumination, represented by the colour vector (C,α) is scattered by a material.

We have been thinking of colour as a vector. Colours can be represented by vectors (c₁,c₂, . . . , cₙ₋₁), where each coefficient cᵢ is a scalar quantity representing the amount of energy in, or centred on, the i-th frequency channel being sampled or represented. These frequencies are often in the visible part of the electromagnetic spectrum but may cover any part of it. It is convenient but not essential to arrange these in increasing frequency order. It is possible to add two such vectors, possibly scaled, to produce a new colour anywhere on the line in colour space which goes through both.

For coloured materials, we may use a similar vector form, with the cᵢ now representing reflection coefficients (for opaque materials) or transmission coefficients (for transparent materials). If A is the colour vector of the illumination and B is the colour vector of a material, then we multiply the channels term by term to determine a vector representing the colour reflected (for opaque materials) or transmitted (for transparent materials). That is, the resultant colour is

(a₁b₁,a₂b₂, . . . , aₙ₋₁bₙ₋₁)

The number of colour channels may be freely chosen to suit the application. The chosen representation may be integer or floating point, again to suit the application. For many computer applications there are three channels, representing red (R), green (G) and blue (B); this is convenient for displays which use such a representation. In computer applications it is necessary to decide how many bits to associate with each value. It is common that 8 bits are used for these colour channels, again to suit the needs of displays. However this number may advantageously be greater, either to avoid loss of accuracy with colour calculations, or to permit linear calculations to cover the range of the human eye (which is not linear), or both.

According to the invention, to represent colour, we use a projective transformation, conveniently represented as a matrix. For a transformation to be projective, it must be invertible. A general n×n colour projective transformation has the matrix form:

$$( \begin{matrix}{c}_{1 , 1} & {c}_{1 , 2} & … & {c}_{1 , n - 1} & {v}_{1} \\ {c}_{2 , 1} & {c}_{2 , 2} & … & {c}_{2 , n - 1} & {v}_{2} \\ ⋮ & & & & \\ {c}_{n - 1 , 1} & {c}_{n - 1 , 2} & … & {c}_{n - i , n - 1} & {v}_{n - i} \\ {t}_{1} & {t}_{2} & … & {t}_{n - 1} & α\end{matrix} )$$

Our interpretation of this is as follows. The elements cᵢⱼ define the basic colour. The main diagonal elements c_{i,i} correspond to the traditional colour vector coordinates. Non-zero off-diagonal cᵢⱼi≠j elements represent fluorescence. The elements tᵢ allow a colour translation, such that we can apply a colour shift or offset. The elements vᵢ allow colour vanishing points to be set, permitting colour differences to reduce with alpha. The alpha value is interpreted by us as the volume containing the colour, not as a coverage factor.

We note that there can be any number n of channels in total but there is always a single alpha value. If the off-diagonal values are all zero, then this is a diagonal matrix and it becomes equivalent to an n-channel alpha vector. However, unlike earlier work, n is not necessarily four. Others have used multi-channel colour vectors but not extended with a single alpha value. Others have used multiple alpha values; an advantage of our approach is that we only need one. Porter and Duff used only 4-channel alpha vectors.

### EXAMPLE

### 4 Channel Diagonal Matrix

$$A = ( \begin{matrix}r & 0 & 0 & 0 \\ 0 & g & 0 & 0 \\ 0 & 0 & b & 0 \\ 0 & 0 & 0 & α\end{matrix} )$$

We see that conventional alpha-colour images are a special case of our approach. Any colour vector, including illumination, can be represented in this diagonal form. Inventively this allows a multi-channel colour vector to have a single alpha. We do not restrict ourselves to channel values which are zero or greater. Inventively this allows negative colour values.

Porter and Duff are aware of alpha values greater than one, treating these as a problem to be solved by clipping prior to display. A display cannot represent colours with alpha values greater than one. We treat alpha more generally: volumes can be arbitrarily large. Inventively this allows utility of alpha greater than one; or any value for alpha, including negative values.

Porter and Duff treat alpha as coverage of colour on a 2D image, as already described. We do not restrict ourselves to 2D but interpret it in any dimensionality as generalised volume. In 1D, this would be length; in 2D, area; in 3D volume; in 4D and higher, hyper-volume.

Inventively this allows alpha representing volume, in any dimensionality.

Since intensity is proportional to energy per unit volume, we treat the colour coefficients as energy and the alpha value as volume, so allowing our vector and matrix forms also to represent intensity.

We interpret alpha as unbounded, not as zero or positive fractional.

This formulation permits us to represent (for example) a material's colour properties with a projective transformation matrix. The off-diagonal terms c_{i,j,}i≠j may be thought of as fluorescence terms. When such a material is illuminated, these coefficients determine how much energy from each in-put illumination channel is transferred to other channels of the output colour.

We will now treat materials as matrices and the resultant output light as the product of the input light and an appropriate matrix. In our examples, we will use the RGBA representation for colour to make clear what the matrix can offer, but emphasise that the results do not depend on this representation. Consider the effect of the general material represented in the following matrix when that material is illuminated by the colour vector shown.

$$( {r}_{i n} , {g}_{i n} , {b}_{i n} , {α}_{i n} ) ( \begin{matrix}{c}_{1 , 1} , {c}_{1 , 2} , {c}_{1 , 3} , {v}_{1} \\ {c}_{2 , 1} , {c}_{2 , 2} , {c}_{2 , 3} , {v}_{2} \\ {c}_{3 , 1} , {c}_{3 , 2} , {c}_{3 , 3} , {v}_{3} \\ {t}_{red} , {t}_{green} , {t}_{blue} , α\end{matrix} ) \qquad Equation 3$$

This is the general projective transformation (provided in practice that it has an inverse). We therefore now consider materials as being a projective transformation over the projective colours. Typical materials will have the off-diagonal elements set to zero (i.e. this will be a diagonal matrix). In particular the translation elements t_{i,j} will be zero and the righthand column will be a unit vector, giving only an affine transformation representing, for example, scatter from materials. The output red, for example, depends only on the input red and the red component of the material.

If we are interested in the conservation of energy, then we have to impose a condition on the matrix coefficients. For example, we usually expect 0.0≦m_{i,j}≦1.0. If we allow other values, then energy is not conserved within that channel.

With the projective transformation, we can represent some unusual materials. For example matrices used to project colours centrally, vertically and horizontally can be thought of as materials with specialised properties.

Hence α comprises the α of the material represented by the transformation and additionally performs the role of the β value representing the ability of the material to reflect light forwards to the viewer, αᵢₙ is the α of the illumination.

Those transformations can be represented in special cases of the general form shown in equation 3 by equations 4, 5 and 6 as follows.

If we place the original energy (C) at P1=(λC,1), then we are positioning this colour energy in a unit area or volume. (We will simply use the term “area” in what follows). If instead we place it anywhere on the line (λC,λ), then we are changing both the energy and the area in proportion. We can think of each as falling on a central projection M_{C} and generated from:

$$( C , 1 ) ( \begin{matrix}λ & 0 \\ 0 & λ\end{matrix} ) = ( λ C , λ ) \qquad Equation 4$$

All these points have the same intensity. They are called pre-multiplied in alpha compositing, where their utility is now seen to be that we can vary the area coverage without changing the intensity, as with an opaque material. Pre-multiplied colours are the natural choice for traditional compositing, where we mask one part of an image with another. There is no change in intensity, only in the area of colour contributing, so we need a reduced alpha. The balancing (1−α) clear contribution is what contributes the reduced opacity.

Now suppose we place (C) at P2=(C,λ) or P2′=(C,λ′)

This puts the original energy (C) in a smaller or larger area, according to λ. This vertical line (C,λ) with λ varying is a line of constant energy but varying area and hence varying intensity, with lower intensity at larger λ. These are non pre-multiplied colours. We can think of each of these as being on a vertical projection M_{V} and generated from:

$$( C , 1 ) ( \begin{matrix}1 & 0 \\ 0 & λ\end{matrix} ) = ( C , λ ) \qquad Equation 5$$

Non pre-multiplied colours distribute a fixed amount of colour in varying area. If alpha increases, this effectively dilutes the colour with black (which an artist would call a “shade”) and reduces the intensity of any light scattered.

To calculate which colour would produce the same intensity as P2 but in unit area, we use a central projection to α=1. The result is P3=(C/λ, 1). This process is known as normalisation, here seen to be changing to a unit area at constant intensity. As shown for P2, λ<1 so this colour P3 has a higher energy than P1=(C,1) but in the same area, resulting in a higher intensity. It will however have the same intensity as P2 because it is on the same radial line. We can think of the downward vertical displacement as squeezing a fixed amount of colour energy into a smaller area, giving a higher intensity. Normalisation can now be interpreted as telling us that this is the same as increasing the energy within the same area. If we start from P2′ where λ>1, we get a P3′ with lower energy than P1 and corresponding comments apply.

Finally, if we place the same colour (C) at (λC,1), then we have changed the amount of energy directly, while keeping the area and underlying colour unchanged. Thus (λC,1) is a line of constant area but varying energy and hence intensity. These are also non pre-multiplied colours. We can think of these as being on a horizontal projection M_{H} generated from:

$$( C , 1 ) ( \begin{matrix}λ & 0 \\ 0 & 1\end{matrix} ) = ( λ C , 1 ) \qquad Equation 6$$

The vertical projection is one of reducing (or increasing) the energy density by moving to a larger (or smaller) area. The horizontal projection achieves the same thing by changing the energy. In either case, the central projection (i.e. normalisation) returns that new density but in unit area. We have to exclude the origin in all cases because here the area collapses and it makes no sense to talk of density. The value α=0 is still useful though, as we discuss in the next section.

Hence, the matrix of equation 4 comprises a central projection which we term matrix M_{C} where the colour energy and area are changed in proportion, corresponding to a premultiplied α compositing value. The transformation of equation 5 is a vertical projection termed here matrix M_{V} corresponding to placing the original colour energy in a larger or smaller area, hence varying energy density, and corresponding to a non-premultiplied α vector. The transformation represented by equation 6 comprises a horizontal projection termed here matrix M_{H}, corresponding to keeping constant area but varying energy and hence energy density.

With these matrices, and if we assume our initial colour is (C,1), we can now express typical image modifiers as:

darken (A,λ)=Mᵥ(α_{A})M_{H}(λ)=(λc_{A},α_{A}) Equation 7

opaque(A,λ)=Mᵥ(λ)Mv(α_{A})=(C_{A},λα_{A}) Equation 8

dissolve(A,λ)=Mᵥ(α_{A})M_{C}(λ)=(λC_{A}λα_{A}) Equation 9

where λ represents the extent of each modifier operation. In particular it can be seen that the transformation matrix here can act on a single image represented by each of the pixels RGBA to modify the image by darkening, rendering opaque or dissolving with corresponding factor λ.

The darken operator is a constant coverage function: it changes only the colour energy. In consequence, if we divide through by alpha we do indeed get a darker version of the colour we started with. In our terms darken is a neutral density filter.

The opaque operator is a constant colour energy function: it changes only the coverage. The colour component is still pre-multiplied by the unscaled alpha, but the alpha component is now scaled. Alpha division will therefore not recover the original colour but rather one that is brightened to give the same colour effect at the new coverage. As Porter and Duff recognised, it can result in colours greater than unity, which Porter and Duff ultimately clip.

The dissolve operator is a constant intensity function: it scales both coverage and colour, such that we can recover the unscaled original colour by alpha division.

More conventional effects and materials can also be represented including fluorescence, colour shift, multispectral colour, scattering, filtering and scaling and α compositing.

For example, fluorescence occurs when one of the output channels picks up energy from other than its corresponding input channel. We can incorporate a colour shift operation by using the t_{i,}_{ⱼ} elements in the bottom row. We can generate overall scaling of the result, such as we night need for further colour calculation, by the choice of aₘₐₜ. We can also impose a vanishing direction on any or all colour channels, by the choice of vᵢ.

Turning to some basic practical examples, we will revert to the single C value for colour but it will in practice expand to several independent channels.

We make a colour shift by translation:

$$( α C , α ) ( \begin{matrix}1 & 0 \\ t & 1\end{matrix} ) \qquad Equation 10$$

The premultiplied form is the colour placed at the correct scale. The alpha value of the original illumination thus scales the translation value so that it is correct for the colour space of the illumination (and therefore of the result).

Hence a 5×5 matrix operator is not required for RGBA colour shift. In particular a fifth row of colour translation values is not required, in the sense that we now see that the 4×4 is already in homogeneous form. Rather than having the translation and the alpha separately, these terms must be made to interact in the way just described, as the homogeneous space indicates.

A further achievable effect is fluorescence. We can get cross-frequency effects by putting non-zero elements off diagonal in the colour sub-matrix, the elements m_{i,j}. In RGB, for example, the resultant blue can depend on the incoming red, green and blue, giving fluorescence. If energy is to be conserved, the matrix elements must be chosen accordingly but there is nothing in the mathematics to require that. It is therefore possible to invent effects which depend in imaginative ways on non-realisable materials. For example, we can construct filters which do not have a direct physical correspondence, such as one to generate a greyscale image from a colour one (or indeed to scatter the average of the incoming colour). Another example is to create fluorescence from an up-shift in frequency, from red to blue, which is the reverse of what happens in reality.

Turning now to multi-spectral colour, all the processes can be applied in the multispectral case, where there may be many channels of colour. With our approach, only one alpha is needed, no matter how many channels are used to represent the colour further as will be explained later.

We may include off-diagonal terms in the material matrix. Combining this with a multi-spectral representation allows such effects as showing in visible colours an image illuminated in the infra-red, as a sniper-scope would.

If we wish to scatter illumination of colour (C₀,α₀) from a surface of colour (C₁,α₁), we use term-by-term multiplication from a matrix transformation built from the reflection coefficients of both C and α:

$$( {C}_{0} , {α}_{0} ) ( \begin{matrix}{C}_{1} & 0 \\ 0 & {α}_{1}\end{matrix} ) = ( {C}_{0} {C}_{1} , {α}_{0} , {α}_{1} ) \qquad Equation 11$$

The matrix represents the effect of the material on the in-coming light (C₀,α₀).

It offers independent scaling of each component of the colour vector. For common materials, we expect the scattering coefficients to be fractions or we can create exotic “super-dense” materials which scatter more than the incoming energy, to help get the desired visual out-come. Such materials may well be more desirable than physical reality in special effects, cartoon animation and other artistic applications.

The most general case is multi-spectral calculations, with projective transformations and alpha. To give a specific example, visible light multi-spectral calculations are preformed at (typically) 31 frequencies, enough that the eye cannot resolve the difference between two adjacent ones. 32 channels are used, adding an alpha to the colours. The projective transformation is then a 32 by 32 matrix. An image has one such transformation at each pixel. All colour values, such as the illumination or the output colour are 32-vectors.

Filtering is mathematically the same as diffuse reflection (scattering). We can adjust the colour of an illuminated surface by viewing it through a filter or we can illuminate a surface with a filtered colour. Either way, the scattering calculation is the same. Accordingly to achieve a filtering effect it is simply necessary to adopt the appropriate colour or image.

In the approaches described above, projective transformations are used to show the effect of a material, represented by the 4×4 matrix, on illuminating light represented by an RGBA value. In a simple approach, therefore, the effect of illuminating each pixel of a material with a single colour of light could be achieved by computing the output RGBA vector for each pixel of the material illuminated by a common RGBA input vector. Alternatively this approach can be extended to compositing or other combination where the input RGBA vector corresponds to an illuminating pixel of an input image, for example an image A, illuminating a further image B whose properties are represented, pixel by pixel, by the 4×4 transformation matrix. In that case the effect at a given pixel can be schematically represented as shown in FIG. 5 in which the contribution of an image A, having value (C_{A}, α_{A}) at a given pixel and an image B having a value (C_{B}, α_{B}) at a corresponding pixel provides four regions corresponding to the various combinations of the opaque (α_{A}) and clear (1−α_{A}) part of C_{A} and the corresponding portions of C_{B} for that pixel. In particular the four regions are labelled AB, A, B and 0 in FIG. 5 corresponding to A combined with B (Region AB) A alone (Region A), B alone (region B) and a clear Region 0.

This corresponds to an opacity model and visual representation similar to that of Oddy and Willis (FIG. 5) and shows two overlapping coloured but not wholly opaque layers, represented with the two axes showing their alphas. We can visualise the density of particles in the front layer simply by dividing the unit square into a clear and a coloured section, as though all the particles of colour A have been swept to one side. For the rear layer we sweep all the particles of colour B downward. There are now four regions within the unit square. Region 0 is clear. Region A has the colour of layer A. Region B has the colour of layer B. Region AB is the area where the particles overlap. The respective areas of these regions represent the proportions of clear, A-colour particles, B-colour particles, and where both particles of both colours fall. These areas also show how the energy densities associated with the two colours are combined, with no assumed ordering of the layers.

Using this representation to visualise the colour interactions together with the projective transformation matrices on a pixel-by-pixel basis allows conventional and non-conventional α compositing techniques and other effects such as light interaction with material to be applied.

For example, Porter and Duff's compositing formulae result from assuming that Region AB consists of either colour A or colour B, a consequence of their assuming an “overpaint” model of colour combination.

We consider three aspects of how energy interacts with a material: transmission, reflection and absorption. Absorption amounts to heating of the material by some of the in-coming energy. Real materials have mass, giving a time dependency to any heating effect. We will ignore this time dependency for our purposes, though it could clearly be modelled with existing techniques. From the conservation of energy:

illumination=transmitted+reflected+absorbed

where each term is energy. We can model this independently for each illumination energy source.

Transmission and reflection are computationally the same, though conceptually different. Absorption can be thought of as fluorescence: some of the incoming energy is moved to one or more infra-red channels. In most computer graphics calculations, the absorbed energy is not used or calculated explicitly. Hence, according to further inventive aspects, absorption can be included in the matrix; and/or one such matrix can be used for each of the resultant transmission, reflection and absorption energy densities; and for the illumination energy density; and/or a single matrix can be used to represent the material, where the illumination is known and one of the resultants is known to be zero or can be ignored.

We envisage a layer of material, illuminated from the front by colour C. If there is illumination to the rear as well, the calculations are independent and the results may be added. The viewer is conceptually to the front of the layer. For consistency of terminology, we will assume reflection gives a “forward” result C_{F} and that transmission gives a “rearward” result C_{R} and that any remainder is the absorbed result C_{X}. We will describe the calculations for a layer in which colour is uniform and represented by a projective transformation. (The case of layers which vary in colour discretely or continuously may be handled by any means which identifies the appropriate projective transformation at any location.) Although alpha may represent any volume, it is convenient for this description to think of a unit volume of material. Thus a volume a of colour in a unit volume of material leaves a volume (1−α) which is clear. This approach permits us to think of the colour as being made up from two components which can be separately calculated: an amount α which is of the colour represented in the projective transformation and an amount (1−α) which is completely clear. (In our example, illumination will be calculated by the matrix product although other combiners could be used to different effect.)

First suppose we illuminate a transmissive material (a filter), of colour represented by projective transformation C_{B}, which is to be illuminated by colour of projective transformation C_{A}. The relevant entries of C_{B} may be interpreted physically as transmission coefficients.

Since an amount (1−α_{B}) is completely clear, a proportion (1−α_{B}) of the incoming illumination will pass directly to the rear. The illumination is α_{A}C_{A} so the rearward contribution from this first calculation is

C_{R1}=α_{A}C_{A}(1−α_{B}) Equation 12

An amount of material α_{B} of C_{B} interacts with the colour of the illumination. Because the material is transmissive, this produces a rearwards contribution. We calculate this as:

C_{R2}=α_{A}C_{A}α_{B}C_{B} Equation 13

There is no illumination reflected to the front so the outcome may be summarised as:

C_{F}=0

C_{R}=C_{R1}+C_{R2}=α_{A}C_{A}(1−α_{B})+α_{A}C_{A}α_{B}C_{B} Equation 14

We now describe the calculation for a material which reflects rather than transmits. The relevant entries of C_{B} may be interpreted physically as reflection coefficients.

The calculation for the clear area is unchanged by this, so contributes the same rearward amount as before. The colour calculation for the remaining amount of illumination is also unchanged but this amount will now be reflected forwards. The outcome is thus:

C_{F}=α_{A}C_{A}α_{B}C_{B}

C_{R}=α_{A}C_{A}(1−α_{B}) Equation 15

The areas of the regions determine the weighting to be applied to each colour. Region AB here has a colour which is the matrix product of the two contributing colours. In line with our earlier description, one way to envisage this is to treat the illumination C_{A} as “photon particles”. For reflection, some of these pass through the clear part of B and continue to the rear and some reflect from the pigment in the A particles, producing a colour which depends on both. For transmission the latter also pass to the rear. As we are only considering illumination, there is no Region B contribution to these results. The B colour only contributes where it is illuminated, in Region AB.

In all case the colours are projective transformations. We note that these transformations always appear multiplied by their respective alphas. This leads us to extend Porter and Duff's pre-multiplied colour vectors to pre-multiplied colour matrices. In such a matrix, the coefficients contributing to the colour calculation are each multiplied by the alpha of the matrix. A particular virtue of our approach is the inclusion of alpha within a transformation. It also follows that extending the Porter and Duff pre-multiplied alpha colour vectors to pre-multiplied projective transformation matrices will give similar efficiency benefits. Further inventive aspects therefore include pre-multiplied colour matrices and vectors providing an efficiency benefit.

We can also give a physical interpretation to pre-multiplied forms. They represent a specific volume α of the material. Smaller volumes scatter less energy of the original colour, which the alpha-scaled coefficients represent. Similarly larger volumes scatter more energy of the original colour. The pre-multiplied form is thus the natural representation for many materials. Varying the alpha of a non pre-multiplied colour causes its intensity to vary, as there is a fixed amount of energy in a varying volume. Physical interpretations of this include diluting a varying amount of coloured liquid in a clear one, or suspending a mass of water droplets in air to create mist, or suspending insoluble particles in a fluid.

We will represent the pre-multiplied version of C as c, allowing us to simplify these formulae as follows.

For transmission:

c_{F}=0

C_{R}=C_{A}(1−α_{B})+c_{A}c_{B} Equation 16

For reflection:

c_{F}=c_{A}c_{B}

c_{R}=c_{A}(1−α_{B}) Equation 17

In either case, if the amount absorbed is not represented explicitly in the transformation, then it may be deduced as needed from the conservation of energy as a third resultant projective transformation C_{X}. In general:

C_{X}=C_{A}−C_{F}−C_{R} Equation 18

We may summarise these calculations in the following terms. Transparent and clear materials permit rearward (transmitted) energy only; opaque materials permit forward (reflected) energy only; intermediate ones yield both. The value (1−α) of the material determines what proportion of the impinging energy continues rearwards, its colour unaffected by the material. A proportion α is accounted for by the absorption and reflection combined. The colour reflection coefficients determine what proportion of this energy is reflected; the rest is absorbed. It is also possible to interpret the matrix as containing transmission coefficients, with corresponding results. A further inventive aspect is hence light interaction with material, via the projective transformation.

Equations 12 to 18 are not compositing formulae: we are considering one layer of material interacting with incoming illumination.

Moreover, there are two resultants C_{F} and C_{R} which are themselves projective transformations. Conventionally there is one result, a colour or alpha colour value.

If absorption is zero, what is transmitted is the balance after what is reflected and so the conservation law reduces to

C_{A}=C_{F}+C_{R}

We can model a pure reflector or a pure filter by assuming that the remaining energy is absorbed. This is the common way in computer graphics calculations; only the energy reflected or transmitted is calculated while that energy lost to absorption is not.

Both of these approaches can be represented explicitly in one projective transformation matrix, for example by including an infra-red channel. We can choose coefficients which represent energy conservation by forcing the absorbed energy into one or more such channels, as in this five-channel projective transformation example.

### EXAMPLE

### Absorption Channel

$$( \begin{matrix}0.2 & 0.0 & 0.0 & 0.8 & 0.0 \\ 0.0 & 0.3 & 0.0 & 0.7 & 0.0 \\ 0.0 & 0.0 & 0.5 & 0.5 & 0.0 \\ 0.0 & 0.0 & 0.0 & 1.0 & 0.0 \\ 0.0 & 0.0 & 0.0 & 0.0 & 1.0\end{matrix} )$$

This means that all three resultant transformations C_{F}, C_{R} and C_{X} can subsequently be used as an illuminant or as a material. In the Example, all rows sum to 1.0, indicating conservation of energy. The incoming colour energies are fully divided among the outgoing colour channels, so all energy is reflected, though with a change in energy distribution. However, if we reduce the 0.8 or the 0.2 in the top row (for example) there will be missing red energy, which in practice would be absorbed energy. If we reduce the alpha value (bottom right corner) to below 1.0, this will permit some of the incoming energy to continue rearwards, unaffected in colour. This will be transmitted energy. For a general method, we therefore need to record both a forward result (due to reflection) and a rearward result (due to transmission). Absorbed energy can be modelled explicitly, as exemplified in the above matrix, or can be ignored if only visible results are required.

By permitting matrix coefficients to be negative as well as positive, we may optionally associate the forward/rearward directions with a sign, plus or minus, to indicate the direction of energy flow. This allows us to distinguish a matrix constructed to represent a transmission effect from one constructed to represent a reflection effect. This permits additional effects, with some channels being transmissive and some reflective. It also permits us a way of representing energy reduction in additive operations. Signed values are not essential. However, it may be more convenient for the intention to be indicated by the operator or through a script describing the required operations. Hence, in further inventive aspects positive and negative colour energies/coefficients and increased range of effects are available, and/or forward results for reflection and rearward results from transmission, both as projective transformations are available and/or a third result (absorption) may either be modelled within the matrices or may be deduced from the known illuminant in conjunction with F and R. It too is a projective transformation; and/or all results are also projective transformations, flexible for practical use.

Materials may be combined by combining their projective transformations. Two such transformations A and B, may be combined in various ways; extensions to three or more such transformations follow directly from the known properties of matrix combination. We may for example add two such matrices in the conventional way, term by term, to give a new colour. This effect is similar to mixing paints, with the respective alphas of the two input colours determining the amounts of each colour. Varying the alphas varies the amount of the paints going into the mixture, with corresponding differences in the resulting colours. This is a new way of calculating this effect. By using the full n×n projective transformation, we avoid the need to represent the volumes or proportions by some additional mechanism. For example, this would be necessary if using only the colour sub-matrix.

We may also combine A and B by conventional matrix multiplication. There are two such products, either AB or BA, because the order matters when matrices are multiplied. Again, if we performed this operation without alpha we would have to represent the amounts by a separate mechanism. Other operations may be devised. A further inventive aspect provides material interaction with material, via combining the projective transformations in various ways allowing useful colour interpretations to the results.

Material combining differs from illuminating a material in an important respect. For combining, all Regions contribute to the outcome. For illumination by A, Region B plays no part.

By giving α a fractional value, the result can be scaled without scaling the illumination, providing compositing operations such as “A over B”. More generally,

C_{R}=α_{A}C_{A}+α_{B}(1−α_{A})C_{B} Equation 19

α_{R}=α_{A}+α_{B}(1−α_{A})

In the projective case, referring to FIG. 5, to get the desired “over” effect, in which the front colour partly blocks the rear, we have to scale down the area of the front colour. In projective terms, we take colour (C_{A},1) and project it to (α_{A}C_{A},α_{A}). In energy terms, we have reduced the amount of energy which this colour contributes by restricting the area. We then take colour C_{B} and reduce its area by (1−α_{A})α_{B}. If we wish to add these two contributions, we do it component by component.

Here is the “A over B” operation, summarised in our terms.
1. A has energy C_{A} over unit area; that is, (C_{A},1).
2. We are constructing a unit area of composite, of which A contributes a fraction α_{A}; so we follow the radial projection in order to establish the energy in this reduced area: (α_{A}C_{A},α_{A})

This is the “(energy contribution, area contribution)” for A. Now we look at what is left uncovered.

1. We have energy (1−α_{A}C_{B}) in area (1−α_{A}); that is, (1−α_{A})C_{B},(1−α_{A})

2. We need this at a fraction α_{B} of the area; that is we need (α_{B}(1−α_{A})C_{B},α_{B}(1−α_{A})).

This is “(energy contribution, area contribution)” for B.

Hence the total contribution is, from term-by-term addition:

(C_{R},α_{R})=(α_{A}C_{A}+α_{B}(1−α_{A})C_{B},α_{A}+α_{B}(1−α_{A}))

which is the same as equation 19 and 20.

In our formulation, it is also possible that we might have result α>1 (though we can still contrive to avoid this if we need to). This simply represents an energy spread over greater than a unit area; greater than a pixel can show, in display terms. This can easily occur in any physical situation. To display it will require normalisation, which will retain the correct colour but constrain it to match the maximum device intensity. This also emphasises that the interpretation in energy density terms is more general than the traditional interpretation of pixel coverage.

Again, known α compositing techniques do not consider filtered compositing. Their choice of composition operators excludes this. In effect they are using an overpainting model. In fact Porter and Duff list only 12 operations, based on colour selection. Operations where both the front and back layers should simultaneously be involved are absent. In our model we can treat these as filtering operations.

The traditional “over” operation is equivalent to spray painting the rear image with the colours from the front image, with the delivered spray density limited to the alpha of the front image. Filtering cannot occur. Oddy and Willis include filtering effects, at a cost of one colour value for the filter and one for the opaque effect. This requires a 7˜channel model (two RGB colours plus one value, which they call beta, to give the opaque proportion). Alternative approaches use 6˜channels, with RGB and separate alphas for each. This does not conform to the 4-channel RGBA model with which it is otherwise used and so must be handled as a special case. It permits the user to set the colour to anything they choose: there is no formal basis, in contrast to our approach. With multi-channel spectral images it is also not practicable to use one alpha per channel. For example 31 colour channels would require 31 alpha values, doubling memory and processing time. Movie post-production companies manage terabytes of data and large increases in storage and processing are commercially infeasible. With our approach, this is not needed.

As noted earlier, a filtering calculation is no different to a diffuse reflection (scattering) calculation. Both take a colour value and multiply it by a fractional value, called the transmission coefficient or the scattering coefficient respectively. It is the multiplication which is the key. Doing this in RGB, with separate coefficients for the three components, allows (for example) incoming white light to be modified to have the colour bias of the filter/scatter material. In both cases therefore, conventional materials scale down the incoming energy and do so selectively in each frequency band. In projective terms, we rescale the incoming energy at a level determined by the material.

Hence, to obtain a filtering effect colour interaction is required, that is a multiplicative function rather than an additive α interaction. Once again the manner in which this can be achieved can be understood with respect to FIG. 5 showing a schematic representation of the interaction between two pixels (C_{A}, α_{A}), (C_{B}, α_{B}) as having coloured and clear regions. It should be noted once again that this does not represent how colours are actually necessarily represented in the pixel which could be by any appropriate density function. Indeed the approaches described extend beyond pixels to any space where a function can be used to represent colour coverage with different regions.

If we wish diffusely to reflect illumination of colour (αC,α) from a material of colour (αₘCₘ,αₘ), we use:

$$( α C , α ) ( \begin{matrix}{α}_{m} {C}_{m} & 0 \\ 0 & {α}_{m}\end{matrix} ) = ( α C {α}_{m} {C}_{m} , α {α}_{m} )$$

The multiplication of the alphas ensures that the result is in the correct pre-multiplied form. Here Cₘ is the “the colour” of the material, in the conventional sense, arranged as a diagonal sub-matrix rather than a vector. It consists of the elements M_{i,j} of the full projective matrix and is zero elsewhere.

In our formulation, it is possible that we might have a result α>1.0. When we normalise this will give us exactly the same colour as we would have had without using alpha at all, so all is well. Indeed the same is true for all non-zero alpha values, including negative alpha. For common materials, we expect the reflection coefficients Cₘ to be fractions but they are not required to be. Coefficients greater than one amplify the energy in that channel, as an image intensifier would.

As described, the colour which results will automatically be in the correct pre-multiplied form. If we instead adjust the bottom right αₘ, without also changing the Cₘ multipliers, we get an overall change of scale. The material is either “super-dense”, reflecting more than the incoming energy, or “super-attenuated”, diluting the energy excessively. Such materials may well be more desirable than physical reality in special effects, cartoon animation and other artistic applications. We are changing the resultant area and hence the energy density of the outcome.

Calculating a filtered colour is mathematically the same as calculating a reflected one. We can adjust the colour of an illuminated surface by viewing it through a filter or we can illuminate a surface with a filtered colour. Either way, the calculation is the same. The only difference lies in the way we imagine the consequences, which in turn depends on the physical arrangement being modelled.

In all cases the C material can be a projective transformation, not just a colour vector. The second case shows a colour multiplication: in the fully projective case this is matrix multiplication, with the usual colour vector interpretation as a special case.

Each image can be an alpha colour image (C is a vector) or a projective material image (C is a matrix). These aspects are significant in extending composition. We can also control the illumination everywhere on an image with another image, not just with an overall setting for the layer. This is useful for grading an image, or to add subtle or strong lighting changes and for local tone control, as we have illustrated.

Hence we can see that if we permit filtering in the case of compositing, we have four cases, depending on the order of the filter (F) and the opaque layer (O). The outcomes of the colour multiplications depend on the order in which the two operands appear.
1. When we place a filter colour A over a filter colour B, the result will be a filter and will have the (transparent) colour which is the product of the two colours.
2. When we place a filter colour A over an opaque colour B, the result will be opaque and will have the colour which is the product of the two colours.
3. When we place an opaque colour A over a filter colour B, the result will be opaque, and will have the colour of A.
4. When we place an opaque colour A over an opaque colour B, the result will be opaque, and will have the colour of A.

Table 1, summarises these Region Operators for Regions AB, A and B. The underscored colours are filter colours, the rest are opaque. The compositing formulae which result from this all require the colour terms to be multiplied by alpha, so they recommend storing colours in this pre-multiplied form. We have here shown that this is equivalent to varying the area at constant intensity. Its intuitive interpretation is that of varying the amount of material. This is a central transformation M_{C}. The original colour can be retrieved by normalisation, the process of dividing through by alpha, provided alpha is not zero.

| | Region AB | Region A | Region B |
|---|---|---|---|
| Area: | α_{A}α_{B} | α_{A}(1 − α_{B}) | α_{B}(1 − α_{A}) |
| F filter F | C_{A}C_{_{B}} | C_{A} | C_{B} |
| F filter O | C_{A}C_{B} | C_{A} | C_{B} |
| O filter F | C_{A} | C_{A} | C_{B} |
| O filter O | C_{A} | C_{A} | C_{B} |

To keep the algebra tidy, we will use premultiplied form, where c=αC. For any operation, we will need two area-weighted colour sums, c_{R} for the opaque elements and cᵣ for the filter elements. These general colour formulae depend on which O/F options we use. If we choose A as a filter and B as a filter, we get

cᵣ=c_{A}c_{B}+c_{A}(1−α_{B})+c_{B}(1−α_{A})

c_{R}=0

α_{R}=0 Equation 21

If we choose A as a filter and B as opaque, we get

cᵣ=c_{A}(1−α_{B})

c_{R}=Cₐc_{B}+c_{B}(1−α_{A})

α_{R}=α_{B} Equation 22

If we choose A as a opaque and B as a filter, we get

cᵣ=c_{B}(1−α_{A})

c_{R}=C_{A}

α_{R}=α_{A} Equation 23

If we choose both layers to be opaque, then we get

cᵣ=0

c_{R}=c_{A}+c_{B}(1−α_{A})

α_{R}=α_{A}+α_{B}(1−α_{A}) Equation 24

In each case we have simplified the formulae where possible. However, what is happening here is that the three regions are being distributed between cᵣ and c_{R} and subject to the colour multiplication, obeying the rules listed earlier.

Region 0 is still present and is clear. This means that it will contribute to the filtering effect, by diluting the filter energy (colour). It has no effect on the opaque colour, so the alpha of the results is that of the total opaque contribution.

The first case gives a pure filter result. The first two cases introduce a colour change, corresponding to the effect of the front filter/light on the rear colour. This is a feature of our new approach because it derives from the colour multiplication.

The second and third introduce a potential to change the colour of any further layers which may later be placed be-hind. Again this is multiplicative. The final case gives a purely opaque result, which is the traditional “over” formula. Comparing this c_{R} with that in the second case, filter over opaque, we clearly see the new multiplicative term extending the available operation. Similar formulae can be derived for other compositing operations.

To cross-dissolve between two images, Porter and Duff introduce another operator, plus:

plus(A,B)=(c_{A}+c_{A}, α_{A}+α_{B})

This is vector addition in our projective alpha colour space. In turn this permits the cross-dissolve to be expressed as:

$$\begin{matrix}xdissolve ( A , B , s ) = plus ( dissolve ( A , s ) , dissolve ( B , 1 - s ) ) \\ = ( {sc}_{A} + ( 1 - s ) {c}_{B} , s {α}_{A} + ( 1 - s ) {α}_{B} )\end{matrix}$$

This is linear interpolation in our projective alpha colour space.

Everything continues to work with all alpha values, including α>1. In practice this means we can control the illumination on each layer and that this illumination can be an image, not just an overall setting for the layer. This is useful for grading an image, or to add subtle or strong lighting changes and for overall tone control.

This generalised filtration/illumination aspect is a significant additional contribution of the new formulation, arising from the energy density model.

Further, novel operations become possible, such as colour addition, giving the same effect as mixing paints. This single model can thus offer overpainting (the Porter and Duff version), illumination and filtering, and colour mixing.

The new approach can include paints, filters and lights on an equal basis; and we can composite them together to an arbitrary degree. Only when we composite such an element onto an opaque element do we get a contribution to the final image. Whenever we composite onto another filter/light element, we modify the filter/light but nothing reaches the final image. This applies pixel by pixel, not layer by layer. Indeed it applies sub-pixel too because each pixel may notionally have an opaque component and a transparent one. A filter/light could also be deemed as a function of space, rather than as an array of pixels.

Alpha refers to the opaque component. The balance of this is (1−α), the filter component. Typically this is made of two parts, the filter itself and the remaining clear component. The filter will reveal layers behind the current layer, with a colour change. The clear component will reveal layers behind the current layer, with no colour change. Putting them together, we can treat them as a single area with a diluted filter effect. The alpha-weighted mixing of these two elements in the previous section ensures that the result correctly reflects this mixture.

Wherever these new compositing formulae have a filter operation, the operation can also be thought of as applying a coloured light, for the reasons given earlier. This is of tremendous practical advantage because it means that we can vary the density and colour of the lighting across any area of the image, by appropriate choice of filter/light. Lights and filters can be images, not just an overall illumination on a given layer. Essentially this is possible because the new general formula includes a colour multiplication alongside the addition present in the traditional one.

Only the opaque colour contributes to the image. The filter/light colour corresponds to the light which continues to any layers behind the ones currently composited. In the traditional approach, we accumulate the output image by working (at least logically) front-to-back through the stack of layers. We accumulate the pixel colour fragments we find, until each pixel is wholly covered. Our approach offers a different and more general interpretation. We think of it as sweeping a wavefront of illumination through the layer stack. At each layer we establish which energy is scattered and add that to our output image. The reduced energy wavefront continues through the stack and may be adjusting by filtering, which will affect the scattered colour further in the stack. At no point do we need to reference pixel coverage or constrain the energies. Compositing is dynamically calculating a colour modifier (the illumination) which ultimately will be applied to opaque material (the images) to produce a contribution to the final image colour.

This interpretation also explains the early beta model of compositing. This included both an opaque colour (the particles) and a filter colour (the medium), with a value β giving the proportion of particles; essentially (C₁, β, C₂). The traditional alpha only captures the opaque colour and its alpha but ignores the energy moving to the rear. The energy interpretation supports the Oddy and Willis beta model, by malting clear that we need a pair of colours. However, it is not essential to have this at every layer or for the final image but only for every intermediate composite, of which there may only be one to render a complete stack. We can retain the conventional (C, α) form and only need to construct an opaque image layer when a group of layers is composited to a single layer. If the intention is to use this within further composition, then we can separately retain the alpha and the rearwards energy. If not, we retain only the composited image.

The division into forward image and continuing wave front corresponds to the forward (F) and rearward (R) buffers. The channels are only needed to hold the R and F buffers and the method uses stock 4 channel (alphα) images, just like industry-standard compositors, but the compositor itself needs 2 buffers rather than one, representing a small cost.

Complex composites over many frames are more efficiently done if unchanging intermediate composites (for example, a background made up of many elements but unchanging across a take) are combined into a single layer, to be combined with varying further layers in successive frames. In our case we need to store two images for this intermediate, but only if we need the full range of operations of our method. It can be a single alpha image otherwise (as traditionally). So we may sometimes need to store 8 channels in the form of two 4-channel buffers but not for every image and not even for every intermediate. The relevance of this low-cost is magnified if we are working with multi-spectral images.

It will be appreciated that the steps discussed above can be implemented in any appropriate manner such as software or hardware and according to any required algorithm for example as represented by the simple flow diagram of FIG. 6. At step 600 the illumination vector RGBAₚᵢₓₑₗ is obtained per pixel. At step 602 the corresponding material matrix values for that pixel are obtained and at step 604 the vector and matrix are applied to obtain the output vector (RGBA)ₚᵢₓₑₗ for each corresponding pixel.

It will be noted that, in terms of the range of colour and alpha values, traditionally the range is [0.0, 1.00], though typically scaled as 8-bit integers [0,225] or higher resolution values (12-16 bits or floating point) for professional use. Because of the energy interpretation the values are unbounded, which means they can be used for any colour calculation, whether intended for display or not; and only need to be range limited when a picture has to be displayed.

The hyperplane (x,y,z,0) does not have finite points, because the scale measure w is zero and such points could not be separated. Its points do have direction however. We use this for ideal (infinite) points, which have direction but no position. We cannot use any other value of w because all such points are finite. Where two Euclidean lines intersect at (xy,z) the homogeneous direction of this point is (x,y,z,1). Parallel lines in the Euclidean plane do not intersect but they do have a definite direction, (x,y,z) say. This direction is (x,y,z,0), the ideal point in the direction of the parallel lines. It is distinguished it from finite points, where w is always non-zero.

The projective space offers a particular interpretation of vanishing points. A vanishing point in a Euclidean space is the image of a point at infinity—an ideal point—in the corresponding projective space. If evenly-spaced points project closer and closer together, they are “in perspective”, with the degree of perspective controllable in each dimension. The points converge on the vanishing point and the direction of projection is the vanishing direction.

Parallel lines exist in colour space. In RGB for example, the colours (λ,0,0) and (λ,1,0) are separated by a constant distance (0,1,0). If the value of λ grows without limit, the colour coordinates of both will tend to infinity. For any finite value, they are still separated by (0,1,0). Once we “reach” infinity however, the two colours become indistinguishable because they differ by a finite amount in an infinite amount. This is an ideal point and it will be in the direction of the lines. In this example the ideal point is (1,0,0,0) in RGBA, with α=0 indicating it is ideal and (1,0,0) is the vanishing direction in the Euclidean sense.

Our energy argument can be used to arrive at the same result. Suppose we start from P1, in unit area, and steadily increase its energy density (i.e. intensity). If we do this in constant area, we move horizontally to P3. If we do this at constant energy, we move vertically to P2. P2 and P3 have the same intensity because they are on the same radial line. As we tend towards infinite intensity, P3 tends to (∞,1) and P2 tends to (C,0). As we do not want to compute with infinite energies, we prefer the zero area representation (C,0), achieved as P2 goes to the limit.

A vanishing point represents a region where the unit steps of (in this case) colour measure have got closer and closer together and are ultimately no longer distinguishable. The α area varies with the colour channel. This is analogous to the w scale varying with distance. Just as we may get w wrap-around so we may get α wrap-around. We are free to generate a vanishing direction in each dimension of our colour space, equivalent to one-, two- or three-point perspectives in 3D geometry. A practical advantage of vanishing points is that a potentially infinite colour energy range can be projected to a finite range of our choosing, perhaps to accommodate the gamut of a display. A further inventive aspect, therefore, is colour vanishing points.

Normalisation in the homogeneous form is not possible when w=0 because (X,0) is an ideal point, a point at infinite distance in zero scale. We do however know its direction is (X). In our colour version, normalisation is not possible when α=0. This is because (C,0) is an ideal point, a point at infinite energy density in zero area. We do however know its finite colour energy is (C) and so we know the direction. A zero-area colour contributes nothing to the final picture, so we never need to normalise it. In compositing, such pixels are discarded as “clear” image.

In our model, the energy density is unrestricted and so we can model in alpha form all light energies, finite and infinite, positive and negative and not just pixel values, which are what Porter and Duff model. For example, the rendering of 3D surfaces or texture mapping with varying transparent texture can now use the alpha form. This remains true even if the areas are microscopic, to the point of being differentials. It should also be clear that we can also composite with negative colour. Such a colour reduces rather than increases the energy contribution. According to another inventive aspect all energies are representable, positive or negative and unbounded large.

According to a second aspect of the approaches described herein, which need not use the projective transformation approach described above nor be restricted to compositing, image information is retained in two independent buffers allowing separate treatment of illuminating and filtering effects, as described above in overview with reference to FIG. 4 and in one aspect with reference to FIG. 5 and forward and rearward resultants C_{F} and C_{R}.

As the additive α model does not provide realistic filtering effects, for example, one possible approach is to take into account the β model discussed above, however it is desirable to move away from the seven channel model currently required for β values. This is achieved, according to the second aspect by providing the rearward and forward buffers separately with respective α values rather than having a single pixel or other value requiring both “material” and “particle” colour values together with β defining the relevant portion. The separate α handle each of the scattered and transmitted light components using the separate buffers to provide the forward and rearward contributions to the image representation.

This can be applied of course for multiple layers. We assume we have a stack of layers as input, each of which consists of alpha colours. We also need a set of instructions telling us how to process each layer. For example:

(A over B) illuminates ((C filter D) over E).

For any operation, the resultant forward-scattered light is accumulated in the Forward buffer and the resultant rearward light is recorded in the Rearward buffer. In each case the new value will be added to the old value, where the operation expects that; but can also for example replace it. Once the instruction stream has been exhausted, the Rearward buffer is discarded and the Forward buffer contains the desired final result.

We can establish how typical instructions update these buffers by again using their Region approach, as in Table 2.

TABLE 2
Examples of the use of F and R buffers

| Operation | Region A | Region B | Region AB |
|---|---|---|---|
| Area | α_{A}(1 − 1α_{B}) | α_{B}(1 − α_{A}α_{B}) | α_{A}α_{B} |
| A illuminate B | R = C_{A} | | F = C_{A}C_{B} |
| A filter B | | F = C_{B} | F = C_{A}C_{B} |
| A over B | F = C_{A} | F = C_{B} | F = C_{A} |

For example, the “illuminate” operation treats the front image as the light source and sends its light rearwards onto the rear image, which reflects some into the F buffer and transmits some to the R buffer. Similarly, the “filter” operation treats the rear image as the light source and sends its light forwards through the front image, which filters it to the F buffer. We can also use the filter variants described earlier, for example to use two filters to construct a new filter.

For all operations, the resultant forward-scattered projective transformations are accumulated in the Forward Buffer and the resultant rearward projective transformations are recorded in the Rearward Buffer. Where the operation expects it, the new value will be composed with the old value; but it can also replace it etc. Once the instruction stream has been exhausted, the Rearward Buffer is typically discarded and the Forward Buffer contains the desired final result. At any stage, the compositor has available the current F and R images and the input layers A and B. The script can use these in any way the operator needs, including the creation of temporary images, saving to file storage, the switching of function between A, B, F and R, etc. Accordingly, a further inventive aspect allows general use of all buffers, due to common representation and/or that matrix operations between them given meaningful colour results.

This arrangement differs from conventional alpha compositing, where we have no concept of illumination and indeed can be used in other approaches such as one layer of material interacting with incoming illumination. Notice also that any layer can serve any purpose: it is the instruction set which determines the meaning to be applied at the point that the layer is used. That meaning can change if the layer appears more than Once. This also permits layers to apply illumination which varies across the whole image, or to provide a colour shift or filtration effect, again possibly varying across the whole image.

Each operation imposes its meaning on the two layers it is compositing. It potentially updates both R (from the rear-moving light) and F (from the forward-moving light). This approach is semantically stateless: at any stage, all we have are the two image buffers, with no further information needed about what they represent. In short, they record the light energy in each of the two directions. This is attractive because each function produces a result of the same form, so the process can be interrupted, the two buffers saved and compositing resumed at any stage. Where a group of layers is unchanging across several frames of a movie, they can be composited together to give a net R and F which can be retained. These buffers are indistinguishable from layers so, later, they can either be loaded into the compositor's buffers and further compositing can take place or they can be placed among a new stack, with appropriate new operations used to combine them.

We now turn to compositing as a specific example which can benefit from our approach. In our method, the following steps are needed to composite two layers, A and B.

1. Apply a region operator to the pair A, B. This generates any regions contributing to the result at that position.

2. If there results a region in which both A and B are present, apply a combiner operation to that region. We represent this as A o B.

3. Accumulate the transmission results into the rearward buffer R.

4. Accumulate the reflection results into the forward buffer F.

Traditionally 12 region operators are available, which Porter and Duff call clear, A, B, A over B, B over A, A in B, B in A, A out B, B out A, A atop B, B atop A, A xor B. It can be seen that several of these are the same operation with the operands reversed. It is perhaps simpler to think of a set of eight region operators which choose which of the three Regions (i.e. other than Region 0) are to contribute. These are all the Boolean combinations of the Regions. As the two operands A and B can appear in either order, this allows 16 operators to be described. There are some redundancies here (for example A xor B is the same as B xor A; and A is functionally the same as B), which is why our formulation is based on eight.

A general means to combine the colours has not been considered by others. Our approach is general and includes the Porter and Duff “overpaint” as a particular combiner, which we can express in our formulation as:

A oB=A

or

B oA=B Equation 25

We generalise in two ways. Firstly, we use projective transformations instead of alpha colour vectors. Secondly, we offer multiple ways of combining the two transformations, as previously described. For example, we simulate paint mixing with:

A oB=A+B. Equation 26

We also permit two forms of multiplication:

A oB=AB

A oB=BA Equation 27

Other operations may be devised, including pragmatic ones.

In Porter and Duff, there are upto three Regions within each pixel, corresponding to colour A, colour B and an overlap area. The region operator determines which of these contribute. When they contribute, Region A is colour A, Region B is colour B and Region AB is colour A or colour B (i.e. “overpaint”). In our case this Region is coloured A oB by our choice of combiner. Among other possibilities, we can composite with paint colours by addition (mixing) or multiplying. Hence the invention further provides the combiner operator stage, with its increased range compositing effects and/or use of forward and rearward buffers.

Although conventional alpha composition operates with a pair of images, there are no terms in which the colour of one affects the colour of the other and this is true for all of the Porter and Duff functions. An immediate consequence is that it is not possible to blend transparent objects correctly. The projective transformation formulation introduces filtering and illumination operations to extend this range, permitting correct transparency calculation. These effects arise because the projective transformation model permits us to combine material colours

Of course different functions can be applied at different pixels or geometry regions such that in some regions a simple paint operation can be applied whereas more complex operations can be applied in another region once this has been done for a pair of images. The result is another image which can then be combined with any further layers. In addition to providing advantages over previous β model proposals, the advantages over α compositing are clear and can be further understood with reference to FIGS. 7A to 7C which comprise images to which processing has been applied corresponding to the images of FIGS. 2A and 2B. In particular, alpha compositing cannot create effects where there is layer-to-layer colour combination, rather than simple interpolation as here. However FIG. 7A shows the new “Illuminate” operation. FIG. 7B is the Forward buffer and FIG. 7C is the Rearward buffer image. The physical model is that the front image is treated as a coloured light, illuminating the rear image of the face. The result on shows no fogginess but resembles the face re-lit. The comparison with the traditional alpha result of FIG. 2C, is striking. There is no background spill and the face has a natural look which is lost in the alpha version.

FIG. 7A is the composition of the Forward and the Rearward images, obtained by compositing FIG. 7B and FIG. 7C. The result is a realistically-lit effect, very different to the alpha blend of FIG. 2C. A conventional “over” operation would give the same geometric arrangement of the two components but the face would not pick up the lighting effect from the colour splash.

The initial images have alpha set to 1 or 0 (except around the edge of the face) but proportional effects can be achieved with fractional alpha, giving a genuine translucency effect: the light passes through the object and illuminates whatever is beyond.

The “filter” operation produces the same forward buffer F FIG. 7B but the rearward buffer R is wholly black. In this case the physical interpretation is that the face image is self-luminous and its colours are filtered through the colour splash, so there is light energy moving towards the viewer but none moving away. A typical use for a filter is to adjust the tonal balance of the layer behind it, without affecting other layers in the stack. In our case it places different lighting effects on the face and on the upper body.

Both buffers are themselves alpha images so they can be freely deployed to suit the need: there is no requirement that either buffer retains the same semantics. The R and F images could instead be combined with the R image FIG. 7C displaced, to give the effect of the head casting a shadow, with the shadow surrounded by the brightly coloured light also illuminating the face. Similarly either can at ally time be replaced by an alternative image. This gives control in depth of the lighting and filtering effects, in ways not open to traditional alpha compositing. In all cases the C material can be a projective transformation, not just a colour vector. The second case shows colour multiplication: in the fully projective case this is matrix multiplication, with the usual colour vector interpretation as a special case.

Each image can be an alpha colour image (C is a vector) or a projective material image (C is a matrix). These aspects are significant in extending composition. We can also control the illumination everywhere on an image with another image, not just with an overall setting for the layer. This is useful for grading an image or to add subtle or strong lighting changes and for local tone control, as we have illustrated.

According to the third aspect of the invention, the approaches described in the first and second aspect can be combined. In this case, light from the rearward buffer impinges on the front of an image and light from a forward buffer impinges on the rear of an image. The image itself is represented as a material in the form of a transformation matrix and provides a corresponding forward-emanating image representation in its own forward buffer formed of the transmitted (filtered) light from the preceding forward image buffer and the collected (scattered) light from the incoming rearward buffer, together with its own rearward buffer comprising the reflected (scattered) light from the incoming forward image buffer and the transmitted (filtered) light from the incoming rearward image buffer. Once again the scattering and filtering components can be selected by appropriate selection of values of α in the incoming forward and rearward buffers and in the material buffer such that a range of compositing operations can be adopted.

We can composite projective image filters and lights together to an arbitrary degree and produce a net illuminant or filter for later use. This is of tremendous practical advantage because it means that we can vary the density and colour of the lightning across any area of the image, by appropriate choice of filter/light. When we subsequently composite such a filter or light onto an opaque element, we get a contribution to the final image. A filter/light could also be defined as a projective function of space rather than as an array of projective pixels, or derived from a 3D rendering.

As a specific example for overpainting, the rear layer is visible only in proportion to the (1−α) of the front layer, which is wholly visible and so contributes in full. Overpainting requires the proportions to be α_{A} of the front colour A and 1−α_{A} of the rear colour B. The traditional overpainting operator is thus a tightly restricted form of our general addition. In our approach we extend overpainting from the vector form to our matrix form and so both include it and extend its possibilities. Here are some RGBA examples in matrix form.

$$A = ( \begin{matrix}0.2 & 0.0 & 0.2 & 0.0 \\ 0.0 & 0.3 & 0.4 & 0.0 \\ 0.0 & 0.0 & 0.3 & 0.0 \\ 0.0 & 0.0 & 0.0 & 0.4\end{matrix} )$$

$$B = ( \begin{matrix}0.1 & 0.0 & 0.1 & 0.0 \\ 0.0 & 0.3 & 0.5 & 0.0 \\ 0.0 & 0.0 & 0.0 & 0.0 \\ 0.0 & 0.0 & 0.0 & 0.6\end{matrix} )$$

$$A over B = ( \begin{matrix}0.116 & 0.0 & 0.116 & 0.0 \\ 0.0 & 0.0228 & 0.034 & 0.0 \\ 0.0 & 0.0 & 0.012 & 0.0 \\ 0.0 & 0.0 & 0.0 & 1.0\end{matrix} )$$

$$A plus B = ( \begin{matrix}0.3 & 0.0 & 0.3 & 0.0 \\ 0.0 & 0.6 & 0.9 & 0.0 \\ 0.0 & 0.0 & 0.3 & 0.0 \\ 0.0 & 0.0 & 0.0 & 1.0\end{matrix} )$$

We further propose materials of any dimensionality can be composited. For example, illumination with volumes for volume rendering, images with images, images with illumination, volumes with images etc. In another inventive aspect, therefore, compositing objects of any dimensionality with other objects of any dimensionality, not necessarily of the same dimensionality is possible.

Compositing two projective transformations yields another projective transformation. However, because of our earlier energy considerations, we will output two projective transformations, one representing the forward energy result (due to energy reflection) and one the rearward (due to transmission). In this application, absorption is not usually considered so we will omit it from our description, noting that it could be included as a third result, as described earlier.

At any time we might choose to view a projective transformation, which we can do by multiplying it by an illumination vector. Such a vector is itself a special case of a projective transformation, being equivalent to a diagonal matrix as already noted. The same operation can also be used to yield a projective transformation with only the visible terms remaining (i.e. the main diagonal), which is useful for constraining effects in complex composites. Similarly we may force any term to zero from time to time, for the same reason. In another inventive aspect there is provided combined energy and volume representation and/or that matrix effects are directly controllable, with meaningful physical interpretation.

The manner in which a two-buffer operation of the type described in the second and third aspects of the invention can be implemented can be further understood with reference to FIG. 8.

In our method, the following steps are needed to composite each pixel from two layers A and B.

At step 800 a region operator is applied to the pair A, B. This generates any regions contributing to the result at that position, that is the respective contributing regions of each pixel as described above with reference to FIG. 5. At step 802, if the results a region AB, in which both A and B are present, a combine operation A o B is applied to that region. The combiner operation could be any appropriate operation, for example a projective transformation or any operation between projective transformations of the type described above. At step 804 the transmission results are accumulated into the rearward buffer R and at step 806 the reflection results are accumulated into the forward buffer F.

We will now give a practical example of a compositor based on our new approach. We will choose RGBA colours and so our transformations will require 4×4 matrices; that is, 16 channels. Materials and illumination will be at most 16 channels. The method adjusts in the obvious way for more or fewer channels. We will assume that forward and rearward results are captured in an F buffer and an R buffer respectively; and that we have input images in buffers A and B. In all cases each pixel of each image is a projective transformation.

We have described combining operations such as multiplication and addition. These may optionally be applied before any compositing operation. They proceed pixel by pixel, using A and B as the inputs and the resulting output can be placed in A, B, F or R, at the operator's choice.

Suppose that B contains a material which we wish to view. We load A as a diagonal matrix, with the illumination vector. A simple matrix product of these buffers will put the required (diagonal matrix) image in F. This is in effect a rendering operation.

If we wish to mix the two materials, we perform matrix addition. If we wish to adjust the colours of a layer directly, then we load A with one of the operators M_{V}, M_{H} or M_{C} or some other transformation and put the image in B. The resultant is the matrix product.

If we wish to perform a compositing operation, the compositing operator determines which Region's results are accumulated into the F buffer and which into the R buffer. These results may also be stored for later use. It also determines both a combining operation and a region operation. At each pixel, the region operation decides which of the Regions A, B and AB will be coloured and which will be clear. If the region operator has selected it to be coloured, the combiner operation decides the colour of Region AB. In practice the out-put calculation for each choice of region and combiner operations can be worked out in advance, giving the opportunity for an efficient implementation.

By way of example, suppose we wish to combine A and B with the compositing operation “filter”. That is, we wish to calculate the effect of A filter B, where A is treated as transparent and B as opaque. The region operator for filter must select Region AB and Region B. The combiner operation is matrix multiply. The result must be placed in the F buffer. Here we are effectively assuming that B is self-luminous, filtered through A.

For a second example, consider the closely-related compositing operation A illuminate B, where B is again opaque. The region operator must select Region AB to generate the F result and Region 0 to generate the R result. The combining operation is matrix multiply in both cases. Region B does not contribute because it is not illuminated. This example shows the need to allow correctly for Region 0: it does not affect the colour components of the illumination but it does change the alpha value, as the illumination passes through to the R buffer. Region 0 had no role to play in the filter example. If we wish to illuminate from the rear instead, we perform the same calculations but place the previous F result in R and vice versa.

As a further example, suppose we wish to combine A and B with the compositing operation “filter” but this time we will assume that both A and B are transparent. In effect we seek to combine two filters to make a new filter. The region operator for filter must select all Region AB, Region A and Region B. The combining operation is matrix multiply in all cases. The result must be placed in the R buffer.

Other variations to give new effects can readily be devised.

We can use the same general approach for known existing operations. For example A over B is achieved by selecting the three coloured regions, using the combining “overpaint” operator A o B=A in Region AB, and placing the result in F. Similarly A atop B is achieved by selecting Region AB with overpaint and Region B with colour B. The result again goes in F. Even these operations are extended by our interpretation.

In this version, the existing operations all produce results only in the F buffer. It follows that there is another set which produce results in the R buffer.

It will be appreciated that the invention described herein can be implemented in any appropriate manner for example hardware or software for example on a graphics card. A simple diagram of an appropriate apparatus for implementing the method is shown in FIG. 9 including a processor 900 and a memory 902. The processor 900 receives as a data input image data 904 and gives a data output 906. The data output may be obtained by applying the methods described above in the various aspects using any appropriate algorithm encompassed in software or hardware. Where required, access may be made to memory 902 for example for construction and/or output of initial, intermediate or final rearward and forward buffers. The output data may be processed in any manner for example it may be printed, stored or displayed on an appropriate medium as required.

It will be recognised that the approaches described herein can be implemented in any appropriate manner and can be extended, for example, to three dimensional image representations as appropriate. For example in 3D animation it is possible to construct the entire scene as a model which is later turned into frames of film using a 3D renderer whereas in 2D animation the model consists of 2D layers individually rendered into images and brought together by the compositing system. The approaches described above provide an integrated compositor whereby each layer consists of a model from a potentially wide range of types involving an appropriate renderer which returns both colour and geometry information during compositing. The model type may, however, be a 3D geometric model to which the approaches described above can be applied.

The projective transformation approach can be used in volume rendering. Such volumes are typically composed of 3D unit layers, called voxels, each of which has a density associated with it. Such voxels arise naturally from medical imaging, for example. Standard methods exist to generate a picture from this kind of data. For example, a method known as ray-tracing is commonly employed. In this method, a line is traced from the chosen viewpoint through a pixel of the desired image. As the line enters and proceeds through the voxels, various calculations are performed in order to evaluate the way that one or more light sources illuminate each voxel. At the same time, the densities of the voxels that the line passes through are accumulated. When this density reaches or exceeds unity, the calculations cease and the colour calculated so far is placed in the pixel. The process is repeated for every pixel to build a complete image.

In our case we can with advantage represent each voxel with both its density and its colour. The density is represented as alpha. The colour may be generated by similar methods to those already used but applied to each and every voxel in isolation. Compositing techniques such as those described herein may then be used to combine a set of voxels selected for the desired view. This avoids the need to ray-trace every time a new view is required. The invention thus provides use of alpha etc in one or more spatial dimensions for example for one or more dimensional materials, the coverage value α being a colour density value such as an opacity value.

We can composite projective transformations representing materials, filters and lights to an arbitrary degree; and produce (for example) a net illuminant or filter (not possible with Polter and Duff's method) for later use. This is of tremendous practical advantage because it means that we can vary the density and colour of the lighting across any area of the image, by appropriate choice of filter/light. When we subsequently composite such a filter or light onto an opaque element, we get a contribution to the final image. A filter/light could also be defined as a projective transformation function of space, rather than as an array of projective transformation pixels, or derived from a 3D rendering. In an inventive aspect the approach can be used for colour regrading, relighting and filter effects.

In each formula, the colour is multiplied by its alpha. This has the consequence that if we negate both the colour and its alpha, the compositing formula will be unaffected. This is consistent with the projective nature of the space.

The traditional 4-channel alpha ignores the filter/illumination energy moving to the rear. Oddy and Willis recognised the importance of the rearward-moving energy. They included both an opaque colour (the particles) and a filter colour (the medium), with a value P giving the proportion of particles; essentially (C₁, β, C₂). Our new interpretation explains this 7-channel beta model, by making clear that we need two colours and an alpha. However, we now see that it is not essential to have this at every layer but only for every intermediate composite, of which there may only be one to render a complete stack of images. We only need a forward alpha but it makes sense to hold a rearward alpha too: practical compositors can then use either image freely. This also means that all our projective transformation images can be in traditional 4-channel (colour, α) form, if only RGB colours are needed. At any intermediate stage, we need one image for the forward energy and one for the rearward energy. The former is the evolving image; the latter is the evolving illumination or filter.

We have given the description using a 16 channel compositor as an example. Even though the projective interpretation is what led us to the newer operations, such operations can still be used with a conventional 4-channel compositor. The projective colour space gives us a uniform way of describing all operations. What the projective transformation adds is the new material qualities: fluorescence, colour shift and colour vanishing points; and new ways of combining them. If we were worldling with spectral rendered images, we might require 32 channels for the visible spectrum alone. This would require 32×32 matrix transformations and thus 1024 channels. In practice many entries in the projective matrix would be zero. For a software implementation with limited opportunity for parallel processing, it makes sense to identify which channels are non-zero so only those are processed. This can be done by inspecting each matrix before it is used. It can also be done by extending each matrix with a binary code, one bit per matrix entry, with zero meaning the matrix entry is zero and one meaning it is not. It may alternatively be possible to configure the whole compositor when it is known that, for example, every layer and transformation will be in pure RGBA.

Our approach supports the use of multiple channels in varying numbers. For a given sequence of composites, the maximum number of required channels may be known from practical considerations. Further, it may be that some of these channels are known to be zero. A general compositor could therefore be arranged so that only non-zero channels, known to be present, are computed. One way to do this is to provide a preamble to the main compositing script, naming the specific channels needed. For example, it is possible to provide a preamble in a script describing the compositions required. Such a preamble could start with an integer n de-scribing the maximum matrix size n×n and a bit pattern of n² bits to identify the zero and non-zero channels. This permits the available computational resources to be allocated effectively. Such a preamble for alpha compositing would read:

$$\begin{matrix}4 & & & \\ 1000 & 0100 & 0010 & 0001\end{matrix}$$

showing that a 4×4 matrix with only its main diagonals channels is required. Every pixel is composited independently of every other, it is only in the processing of the channels that we need to seek these efficiency gains.

One of the benefits of the projective transformation formulation is that it puts colour and geometry in the same kind of mathematical space. It follows that we can use a compositor to composite geometry. We replace (r,g,b,a) with (x,y,z,w) and continue as before. In the projective transformation interpretation, there are no restrictions on coordinate values: colours can exceed unity or be negative etc, so a fully-competent implementation will cope with any values.

This invention thus provides higher dimensional colour operations, and/or unity of colour operations with geometric transformations. Moreover, as matrices are a particular instance of tensors, everything described herein can make use of multi-dimensional tensors, permitting non-linear transformations varying across the image plane or the source data volume, an inventive step not offered in current compositors.

1. A method of creating a viewable image comprising applying a colour vector or matrix comprising projective colour values and a coverage value to a material represented as a projective transformation matrix including a further coverage value, and rendering the transformed illumination vector or matrix as an image vector or matrix.

2. A method as claimed in claim 1 in which the coverage value comprises an α value, the colour vector comprises an illumination vector and the colour value comprises an illumination value.

3. A method as claimed in claim 2 in which the α value can be less than zero or greater than unity.

4. A method as claimed in claim 1 in which the illumination vector colour values comprises, for example red, green, blue values.

5. A method as claimed in claim 1 in which the matrix transformation comprises or permits one or more of darken, opaque, dissolve, colour shift, colour regrade, fluorescence, multispectral colour, scattering, filtering, subtraction colours, scaling, transmission, reflection, absorption or compositing.

6. A method as claimed in claim 1 further comprising the steps of constructing a forward image representation corresponding to light emanating from the material in a direction towards a viewer and a rearwards image representation corresponding to light emanating from the material in the direction away from a viewer.

7. A method as claimed in claim 1 further comprising creating a viewable image from a second or further material represented as a projective transformation matrix.

8. A method as claimed in claim 1 in which the illumination matrix comprises a colour matrix with diagonal elements as colours and a coverage value and other elements as zero.

9. A method as claimed in claim 1 in which the illumination vector or matrix and transformation matrix represent four or more—dimensional data.

10. A method as claimed in claim 1 in which the illumination matrix or transformation matrix includes, as groups of elements, colour channels, colour translation values and/or colour vanishing points and preferably in which the colour channels can include negative and/or positive colour values in the same or different channels.

11. A method as claimed in claim 10 in which the illumination or transformation matrix can represent spectral or other colour coordinates.

12. A method as claimed in claim 1 in which the transformed illumination matrix, or an operation performed between two material transformation matrices, itself comprises a transformation matrix.

13. A method as claimed in claim 1 in which the material is one or more dimensional and the coverage value is a colour density value, for example an opacity value.

14. A method of constructing an image from one or more image layers comprising, for each layer, constructing a forward image representation corresponding to light emanating from the layer in the direction towards a viewer and a rearward image representation corresponding to light emanating from the layer in a direction away from a viewer.

15. A method as claimed in claim 14 in which the forward and rearward image representation are stored in respective forward and rearward buffers.

16. A method as claimed in claim 14 in which each image layer is represented by respective pixel or voxel information.

17. A method as claimed in claim 14 comprising constructing an accumulated forward and rearward image representation across multiple layers.

18. A method as claimed in claim 14 further comprising constructing a viewable image representation from a forward or rearward image representation from an image layer.

19. A method as claimed in claim 14 in which the forward and rearward image representations are constructed by applying an image function to corresponding pixel values at each layer.

20. A method as claimed in claim 19 in which the image function is defined according to the region within the layer.

21. A method as claimed in claim 14 in which the forward and rearward image representations comprise arrays of colour information and coverage.

22. A method of modelling the light interaction nature of combined first and second materials comprising representing each material as a transformation matrix including colour values and a coverage value and combining the matrices.

23. A method as claimed in claim 22 further comprising applying an illumination vector or matrix comprising colour values and a coverage value to said combined matrices to create a viewable image.

24. A method as claimed in claim 22 in which the combination operation give rise to a resultant transformation matrix.

25. A method of representing colour in the form of a matrix or vector having colour coefficients and a coverage value in which colour operations are performed using projective geometry transformation.

26. An apparatus for constructing an image comprising a processor arranged to implement the method of claim 1.

27. A computer readable medium comprising instructions configured to implement the method of claim 1.

28. A computer implemented method as claimed in claim 1 in which colour vectors or matrices, materials represented as projector transformation matrices or forward or rearward image representations or projective geometry transformations are applied or constructed or rendered or combined using a computer processor.
